(19) United States
(12) Patent Application Publication
(10) Pub. No.: US 2024/0083784 A1
(43) Pub. Date: Mar. 14, 2024

(54) HYDROGEN-RICH WATER SUPPLY SYSTEM USING HIGH- INTENSITY ROTATING MAGNETIC FIELD

(71) Applicants: Sung-Gook LEE, Bucheon-si, Gyeonggi-do (KR); Jin-Gook BOK, Bucheon-si, Gyeonggi-do (KR); SHENG QIAU FANG CO., LTD., Gangseo-Gu, Seoul (KR); PUREPLANTE BIOSCIENCE INC., Toronto (CA)

(72) Inventors: Sung-Gook LEE, Bucheon-si (KR); Jin-Gook BOK, Bucheon-si (KR)

(21) Appl. No.: 18/272,415

(22) PCT Filed: Jan. 19, 2022
(86) PCT No.: PCT/CA2022/050075

§ 371 Date: Jul. 14, 2023

(30) Foreign Application Priority Data
Jan. 19, 2021 (KR) 10-2021-0007450

(51) Int. Cl. C02F 1/48; C02F 1/00; C02F 1/36

(52) U.S. Cl. CPC C02F 1/485; C02F 1/005; C02F 1/008; C02F 1/36; C02F 2201/48; C02F 2209/06; C02F 2209/30

(57) ABSTRACT

The present disclosure relates to systems and methods to generate and supply hydrogen-rich water by activating hydrogen particles while water passes through a high-intensity rotating magnetic field. The hydrogen-rich water generated by the systems and/or methods described herein promotes crop growth without the use of pesticides and can increase yield. The hydrogen-rich water generated by the systems and/or methods described herein is suitable for use in agriculture, including the use with open field crops and house crops, and in smart farms.

### CROSS-REFERENCE TO RELATED APPLICATION

This disclosure claims the benefit of Korean Appl. No. 10-2021-0007450, filed Jan. 19, 2021, the contents of which are incorporated herein by reference in their entirety.

### FIELD

The present disclosure relates generally to systems and methods for generating and supplying hydrogen-reduced water, and more specifically to systems and methods that use ultrasonic rotating magnetic fields for generating hydrogen-reduced water.

### BACKGROUND

All objects have a natural frequency.

Resonance refers to the phenomenon of vibrating with an increased amplitude at a specific frequency that occurs when the frequency of a periodically applied force is equal or close to a natural frequency of the object on which it acts, and that specific frequency is called a ‘resonant frequency’. A resonant frequency can transmit large amplitude and energy even under the action of a small force.

Vibration can appear in mechanics, acoustics, optics, etc. In particular, resonance can occur in electrical and engineering vibration systems.

In electrical resonance, a capacitor and an inductor exchange energy with each other, and have a characteristic in which the impedance changes significantly in the vicinity of the ‘resonant frequency’.

Electrical resonance is used in technologies such as magnetic resonance imaging (MRI), which is widely used in hospitals. In MRI, a strong magnetic field is applied to the human body. Hydrogen atoms of the body absorb a specific frequency energy of external electromagnetic waves resulted from resonance. Depending on the condition of the cells in the body, the energy absorbed by the hydrogen atoms return to an energetically lower state at different times, which can be measured to determine whether or not the cells are diseased or not.

Stress causes various diseases in organisms. In the case of plants, stress arising from drought, flood, cold temperature that have been exacerbated by climate change, or from the increase in harmful reactive oxygen species (ROS) caused by thinning of the ozone layer, adversely affects the growth and reproduction of plants and makes plants more vulnerable to pests and diseases.

Consequently, large quantities of pesticides and antibiotics are used, causing secondary environmental pollutions such as pollution of rivers and groundwater. When humans ingest such plants that have been treated with large quantities of pesticides and antibiotics, various health issues can result, such as decreased immunity, causing vulnerability to diseases.

Humans are also subjected to stress from changes in diet and lifestyle, and from environmental destruction such as pollution and global warming.

The human body is born in a state in which yin (−) and yang (+) are in proper harmony. It is known that if the proper balance of yin (−) and yang (+) is broken, for example by environmental stress, immunity is weakened and the probability of contracting various diseases increases.

It has been confirmed by research that hydrogen has efficacy/effects such as selective removal of harmful reactive oxygen species, anti-aging, and brightening that can counteract the negative effects of stress. Hydrogen also has the benefit of being able to pass through the blood-brain-barrier, which cannot be passed by other antioxidants such as vitamin C. When compared with vitamin C, hydrogen is also anti-inflammatory, anti-allergic, and 176 times more antioxidant power than vitamin C.

Accordingly, it is known that drinking hydrogenated water in which water is electrolyzed or hydrogen gas is directly dissolved is effective in relieving stress in the human body.

Methods to supply hydrogen gas to water are known in the art, for example, Korean Patent Registration No. 10-1186141 (Title: Hydrogen WaterVending Machine which describes artificially administrating hydrogen gas to water).

One problem with such existing technologies is that although the supply of hydrogen water is effective in certain configurations (for example a narrow system or a closed system), in other configurations the supplied hydrogen gas is dissipated into the air (for example when a large surface area is exposed), causing loss of efficacy and beneficial effects of the resulting water. Further, the hydrogen that remains is oxidized to water, resulting in deteriorating quality of the treated water.

Accordingly, there remains a need in the art for new methods and systems to generate hydrogen-reduced water.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

The present invention has been proposed to solve the problems described above in the prior art by providing hydrogen-reduced water generation and supply systems that use ultrasonic rotating magnetic fields to activate hydrogen atoms in water. The present invention is characterized by having a magnetic resonance device (e.g., a miniaturized MRI machine) which provides hydrogen-reduced water when the hydrogen atoms in the supplied water vibrate violently by the resonance frequency and generate thermal energy under ultrasonic rotating magnetic fields. The hydrogen-reduced water generated by the systems and methods disclosed herein is suitable for use, for example, in agriculture including open field crops and house crops and in smart farms. The hydrogen-reduced water generated by the systems and methods disclosed herein can be detrimental to pests and can promote rapid growth of crops, thereby increasing crop yield without the use of pesticides that may be harmful to the human body.

In accordance with one broad aspect of this disclosure, there is provided a hydrogen-reduced water generation and supply system, the system comprising:
a water movement path nested inside and through a main body of the system;
a magnetic field generating unit that creates one or more ultrasonic rotating magnetic fields along the water movement path with power from a power control unit that receives power and controls processes;
and a high voltage generating unit that supplies a high voltage from the power control unit to the magnetic field generating unit.

In some embodiments, the above-mentioned magnetic field generating unit is (a) radially located with respect to the ultrasonic rotating magnetic field (i.e., the magnetic field generating unit may at least partially surround the ultrasonic rotating magnetic field); (b) electronically connected to the high voltage generating unit; and (c) made with one or more core modules composed of multiple cores creating one or more magnetic fields powered by the power control unit. The above-mentioned individual cores of the core module are supplied with power at a sequentially alternating cycle to form an ultrasonic rotating magnetic field along the path of the water. In some embodiments, two or more core modules are arranged in series along the path of the water in intervals, so water passes through more than one ultrasonic rotating magnetic field.

In some embodiments, the system further comprises a storage tank, which is spatially connected through a circulation pipe to the water movement path, to store hydrogen-reduced water. In an embodiment, the system further comprises a circulation pump connected directly to the circulation pipe and applies kinetic energy to the water. In an embodiment, the circulation pipe can be connected to a discharge pipe for discharging the hydrogen-reduced water to the outside.

In an embodiment, the supply pump can be connected to a supply pipe which supplies water from the outside.

When water passes through the ultrasonic rotating magnetic field created by the magnetic field generating unit along the path of the water, hydrogen atoms in the water absorb the resonance frequency energy and create thermal energy by vibrating violently. The quality of the hydrogen-reduced water generated by the systems/methods disclosed herein can be maintained over a long period of time until the absorbed resonance frequency energy is restored to its original state. In addition, the treatment can be performed repeatedly on the generated hydrogen-reduced water, maximizing the quality of the final hydrogen-reduced water.

In accordance with another broad aspect of this disclosure, a method to generate hydrogen-reduced water is provided, the method comprises passing water through one or more ultrasonic rotating magnetic fields to obtain hydrogen-reduced water.

Further, in accordance with another broad aspect of this disclosure, a method for increasing plant growth by growing the plant in the presence of hydrogen-reduced water obtained by the system as described herein. In one embodiment, the plant is a Cannabis plant.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a schematic illustration showing the hydrogen-reduced water generation and supply system using an ultrasonic rotating magnetic field according to an embodiment of the present invention.

FIGS. 2 and 3 are exemplary top views of a magnetic field generating unit (3) according to an embodiment of the present invention.

FIGS. 4 and 5 are schematic illustrations showing the use state of the hydrogen-reduced water generation and supply system using the ultrasonic rotating magnetic field according to an embodiment of the present invention.

FIG. 6 is an exemplary side view of the hydrogen-reduced water generation and supply system (1) according to an embodiment of the present invention.

FIG. 7 is a schematic illustration showing the control state of the hydrogen-reduced water generation and supply system using the ultrasonic rotating magnetic field according to an embodiment of the present invention.

FIGS. 8A-8H are images showing root growth of onions when hydrogen-reduced water (onions labelled 1 and 2), distilled water (onions labelled 3 and 4) or tap water (onions labelled 5 and 6) are used. (A) Start day February 12 at 11:30 pm; (B) Day 3 February 15 at 10:13 am; (C) Day 4 February 16 at 10:35 am; (D) Day 5 February 17 at 8:01 am; (E) Day 6 February 18 at 8:05 am; (F) Day 7 February 19 at 8:36 am; (G) Day 11 February 23 at 8:46 pm; (H) Day 13 February 25 at 10:03 pm.

FIGS. 9A-9B are images of Cannabis plants showing faster growth when hydrogen-reduced water was used. (A) Plants were grown in non-hydrogen-reduced, pH adjusted, RO water; (B) Plants were grown in hydrogen-reduced, pH adjusted, RO water.

FIGS. 10A-10B are results of analysis of cannabinoid contents in (A) Plants grown in non-hydrogen-reduced, pH adjusted, RO water; (B) Plants grown in hydrogen-reduced, pH adjusted, RO water.

### LEGENDS OF SYMBOLS

1: Hydrogen-reduced water generation and supply system
2: Control unit
   21: power supply component
   22: operating component
3: magnetic field generating unit
   31: core
   32: core module
4: high voltage generating unit
5: circulation pipe
6: storage tank
7: supply pump
8: discharge pipe
9: supply pipe
10: magnetic field body
11: inlet pipe
12: outlet pipe
100: water

### DETAILED DESCRIPTION

Various systems and methods are described below to provide an example of an embodiment of each claimed invention. No embodiment described below limits any claimed invention and any claimed invention may cover systems and methods that differ from those described below. The claimed inventions are not limited to systems and methods having all of the features of any one system or method described below or to features common to multiple or all of the systems and methods described below. It is possible that a system or method described below is not an embodiment of any claimed invention. Any invention disclosed in a system or method described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The following is a description of a method for providing hydrogen-reduced water which may be used by itself or in combination with one or more of the other features disclosed herein including the use of any of the features of the systems and/or and any of the methods disclosed herein. All publications, patent applications, patents, figures and other references mentioned herein are expressly incorporated by reference in their entirety.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

The term “consisting” and its derivatives, as used herein, are intended to be closed ended terms that specify the presence of stated features, elements, components, groups, integers, and/or steps, and also exclude the presence of other unstated features, elements, components, groups, integers and/or steps.

Further, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

More specifically, the term “about” means plus or minus 0.1 to 20%, 5-20%, 10-20%, 10%-15%, preferably 5-10%, most preferably about 5% of the number to which reference is being made.

As used in this specification and the appended claims, the singular forms “a”, “an” and “the” include plural references unless the content clearly dictates otherwise. It should also be noted that the term “or” is generally employed in its sense including “and/or” unless the content clearly dictates otherwise.

The definitions and embodiments described in particular sections are intended to be applicable to other embodiments herein described for which they are suitable as would be understood by a person skilled in the art.

The recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about.”

Further, the definitions and embodiments described in particular sections are intended to be applicable to other embodiments herein described for which they are suitable as would be under-stood by a person skilled in the art. For example, in the following passages, different aspects of the disclosure are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Although any methods and materials similar or equivalent to those described herein can also be used in the practice or testing of the present disclosure, examples of methods and materials are now described.

The present disclosure provides methods and systems to treat water using ultrasonic rotating magnetic fields. As water passes through an ultrasonic rotating magnetic field, the hydrogen atoms in the water absorb resonance frequency energy, vibrate violently and generate thermal energy.

The resonance frequency energy absorbed in the water is maintained over a long period of time until it is restored to its original state. Accordingly, the quality of the generated hydrogen-reduced water can be improved.

As used herein, the term “hydrogen-reduced water” refers to water with increased hydrogen (H₂) content compared to non-hydrogen-reduced water. “Hydrogen-reduced water” is also referred to as “hydrogenated water” and “hydrogen-rich water”.

In the case of plants, when hydrogen-reduced water is used in cultivation, the immunity of the plants may be enhanced. As a result, the energy used for responses to stress is allocated for growth, thereby increasing yield. Furthermore, hydrogen-reduced water is detrimental to pests and prevents hatching of pest eggs. The use of hydrogen-reduced water therefore can also reduce the stress of plants from pests without the use of harmful pesticides. Also, when growing flowers, vegetables, fruits, etc., as well as during distribution, hydrogen-reduced water can be used to prevent wilt or rot.

As demonstrated herein, the hydrogen-reduced water generated by the disclosed methods and/or systems can increase crop yield. The present disclosure can therefore contribute to an increase in the income of the farmer by providing hydrogen-reduced water suitable for agriculture (open field crops, smart farms, house crops) and stably nurturing crops through the prevention of pests and rapid growth of crops, thereby increasing the yield, without the use of harmful pesticides.

Further, as demonstrated herein, when hydrogen-reduced water generated by the disclosed methods and/or systems, is used for crop cultivation, root growth increases, the number of fine roots increases, and photosynthesis is activated to darken the green color of vegetables.

Embodiments of the present invention may be modified in various forms, and the scope of the present invention should not be construed as being limited to the embodiments described in detail below. This example is provided to explain the present invention more completely to those of ordinary skill in the art. Accordingly, the shape of the elements in the drawings may be exaggerated to emphasize a clearer description. It should be noted that in each drawing, the same member is shown with the same reference numerals in some cases. Detailed descriptions of well-known functions and configurations determined to unnecessarily obscure the gist of the present invention will be omitted.

Hereinafter, hydrogen-reduced water generation and supply systems using ultrasonic rotating magnetic fields are described in detail with reference to the accompanying drawings.

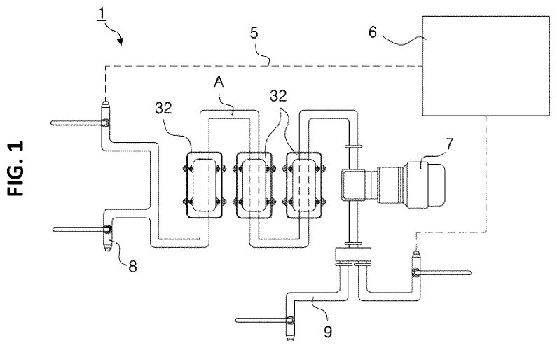

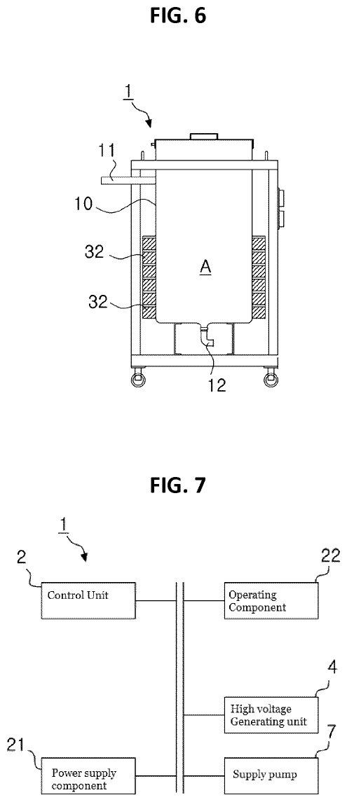

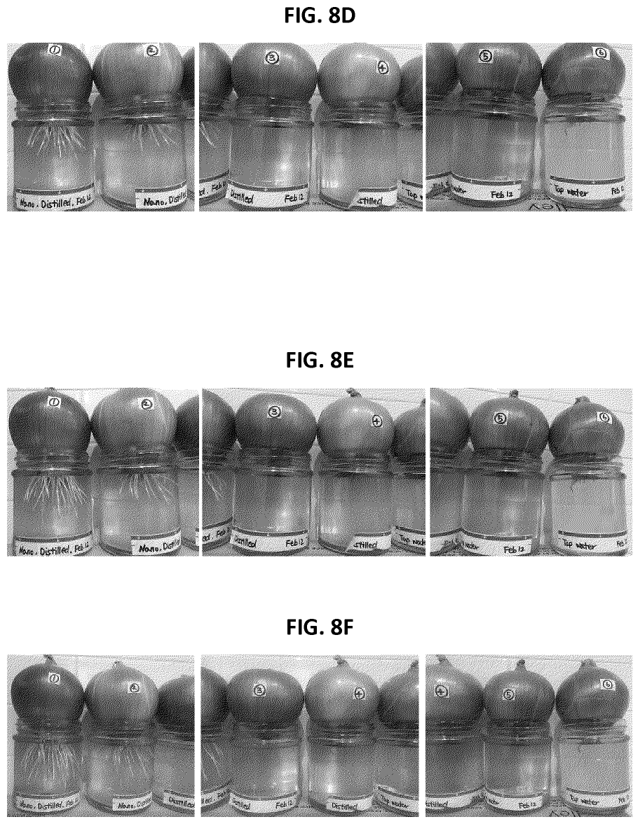

FIGS. 1-8 show embodiments of a hydrogen-reduced water generation and supply system (1) that uses ultrasonic rotating magnetic fields to provide hydrogen-reduced water. The system applies an ultrasonic rotating magnetic field to water (100) within the system, causing hydrogen atoms in the water to absorb specific frequency energy through resonance, so the hydrogen-reduced water can maintain the energy over a long period of time until it restores to its original state.

The hydrogen-reduced water generation and supply system (1) that uses ultrasonic rotating magnetic fields according to the present disclosure comprises:
a path (A) where water moves in the main body of the system (1);
a magnetic field generating unit (3) configured to create one or more ultrasonic rotating magnetic fields along the path (A), the magnetic field generating unit (3) is controlled by a control unit (2) which is powered by a power supply component (21);
a high voltage generating unit (4) that boosts and supplies high voltage to the magnetic field generating unit (3), using power received from the control unit (2).

Power is first supplied to the high voltage generating unit (4) through the control unit (2). From the high voltage generating unit (4), power goes to the magnetic field generating unit (3). Therefore, while water passes through the path (A), high voltages are supplied to the magnetic field generating unit (3) through the high voltage generating unit (4) to form one or more ultrasonic rotating magnetic fields in the path (A).

As a result, water passing through the path (A) is converted to hydrogen-reduced water of pH 7.5 to pH 8 by passing through the one or more ultrasonic rotating magnetic fields.

Without being bound by theory, it is believed that at a molecular level, two things happen when the water in the movement path (A) passes through the one or more ultrasonic rotating magnetic fields. One is re-organizing water through magnetic field. Water is polar, so individual water molecules turn their direction into the same direction as the other molecules.

Secondly, while water molecules re-direct themselves, the water clusters decrease in size. In normal situation, water molecules exist in larger cluster sizes (70-200 Hz in 0-17 NMR). But after the treatment, water reduces its cluster size (40-70 Hz in 0-17 NMR).

In the magnetic field generating unit (3) above, the ultrasonic frequency applied to the path (A) may form an ultrasonic rotating magnetic field. Hydrogen atoms in water absorb resonance frequency energy while passing through the ultrasonic rotating magnetic field, vibrate violently and generate thermal energy.

Accordingly, as the resonance frequency energy absorbed in water is maintained over a long period of time until it is restored to its original state, the quality of the generated hydrogen-reduced water can be improved.

The high voltage generating unit (4) may comprise a ‘high voltage generating structure’ that generates a 12 kV-24 kV high voltage through the control of the control unit (2). The ‘high voltage generating structure’ can be any suitable structure made according to conventional technology and can be appropriately applied. The pH of the water can be adjusted by adjusting the voltage supplied by the high voltage generating unit (4). For example, the voltage may be adjusted using the control unit (2). In one embodiment, the pH of the water is adjusted to a range of about 7.5 to about 8.0.

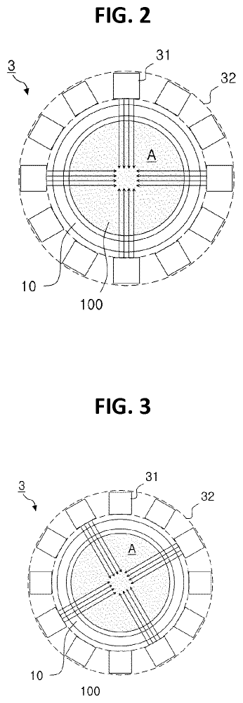

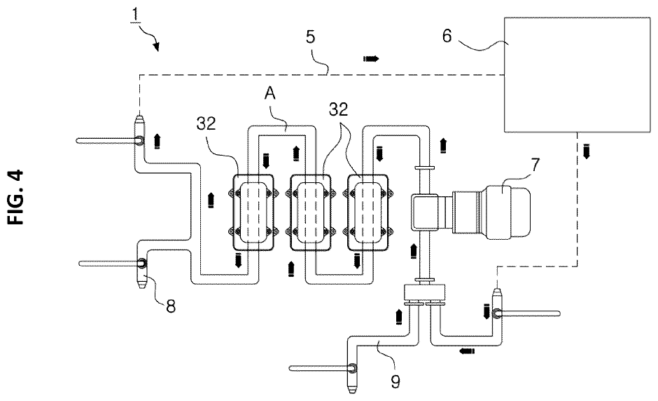

In one embodiment as depicted in FIGS. 2 and 3, the magnetic field generating unit (3) can be radially positioned with respect to the ultrasonic rotating magnetic field in the path (A). In one embodiment, the magnetic field generating unit (3) can be electrically connected to the high voltage generating unit (4). In one embodiment, the magnetic field generating unit (3) can comprise one or more core modules (32) comprising multiple cores (31) that create one or more magnetic fields with power supplied through the control unit (2).

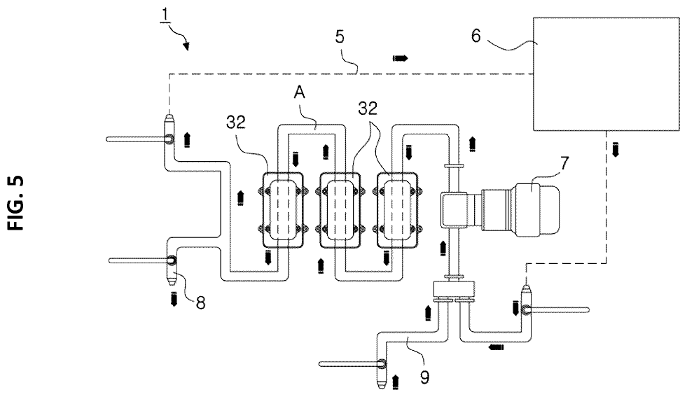

The control unit (2) supplies power in a sequentially alternating cycle to each of the cores (31) in the core module (32) and an ultrasonic rotating magnetic field is created. In a sequentially alternating cycle or pulses, power is first supplied to one pair of cores (341) that are directly opposed to each other in the core module (32). As shown in FIG. 4, power is supplied to another pair of cores (31) in the core module (32) subsequently. The process of sequentially supplying power to pairs of opposing cores (31) in the core module (32) is repeated in a single direction. For example, if the device is composed of 12 cores, core #1 and #6 may be supplied with power first, then core #2 and #7, then #3 and #8.

The control unit (2) provides power to the core (31), for example at a frequency of 50 Hz-100 kHz to form an ultrasonic rotating magnetic field along path (A).

The high voltage generating unit (4) can be designed to receive power controlled through the control unit (2) to generate a high voltage of 12,000V 24,000V.

For example, when a state in which activated hydrogen atoms are mainly required, −6.0 mV to −32.0 mV may be applied in the core (31), and hydrogen-reduced water can be made by adjusted specific Hz. As another example, when a state in which activated oxygen atoms are mainly required, a voltage of +6.0 mV to +32.0 mV is applied in the core (31), to form oxygen-rich water.

The operation of the hydrogen-reduced water generation and supply system (1) according to an embodiment is described as follows.

First, when the user operates a separate operating component (22) and supplies the selected power through the control of the control unit (2) to the high voltage generating unit (4), the high voltage generating unit (4) converts power to high voltages and supplies to each of the core modules (32).

When a high voltage is applied to the core modules (32) as described above, a voltage according to a frequency set to each of the cores (31) constituting the core modules (32) is applied while rotating magnetic force lines are generated and ultrasonic rotating magnetic field are formed over the path (A).

At this time, hydrogen atoms in the water passing through the path (A) absorb resonance frequency energy while passing through the ultrasonic rotating magnetic field and are activated to form hydrogen gas (H₂).

In some embodiments, the magnetic field generating unit (3) comprises one core module (32). In some embodiments, the magnetic field generating unit (3) comprises two or more core modules (32) arranged in series with a distance between each of them over the path (A), so that the water (100) can pass through multiple ultrasonic rotating magnetic fields.

That is, as the hydrogen atoms in the water (100) are sequentially and continuously activated while passing through multiple ultrasonic rotating magnetic fields, conversion to reduced hydrogen is properly performed and the quality and stability of hydrogen-reduced water is maximized.

As a result, the hydrogen-reduced water can maintain high quality and stability for a long time.

The hydrogen-reduced water generation and supply system (1) using the ultrasonic rotating magnetic field according to the present disclosure can further comprise:
a storage tank (6) which is spatially connected to the path (A) through a circulation pipe (5) to receive and store hydrogen-reduced water;
a supply pump (7) connected to the circulation pipe (5) to provide kinetic energy to the water.

In one embodiment, the hydrogen-reduced water generation and supply system (1) can further comprise a discharge pipe (8) connected to the circulation pipe (5) to discharge hydrogen-reduced water to the outside. In one embodiment, the hydrogen-reduced water generation and supply system (1) can further comprise a supply pipe (9) connected to the supply pump (7) to supply water from a source external to the system.

Storage, recovery and hydrogen reduction are sequentially performed through a circulation pipe (5), a storage tank (6) and a supply pump (7) for the hydrogen-reduced water (100) through the ultrasonic rotating magnetic fields generated in the path (A). As it is repeatedly subjected to hydrogen reduction, the quality of the hydrogen-reduced water discharged to a place of use through the discharge pipe (8) to the outside can be maximized.

In one embodiment, consumed activated hydrogen-reduced water can be re-introduced into the system through the supply pipe (9) for further round(s) of treatment.

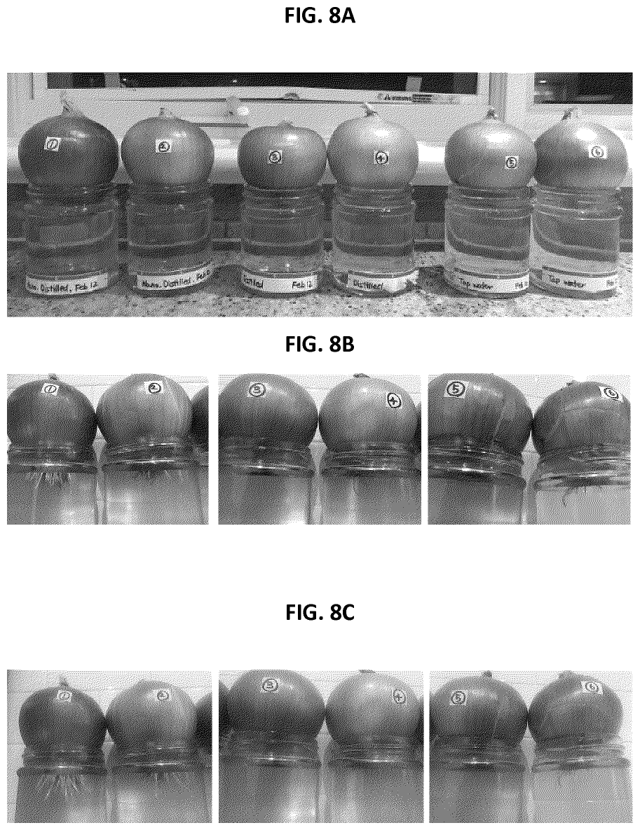

FIG. 6 shows an example in which the hydrogen-reduced water generation and supply system (1) using the ultrasonic rotating magnetic field according to the present embodiment is applied which can be made to include a magnetic field body (10) comprised of:
the path (A) formed inside the magnetic field body (10);
the inlet pipe (11) through which water is supplied;
the outlet pipe (12) through which water passing through the path (A) is discharged to the outside.

The magnetic field body (10) according to the present embodiment can be made as described to have: the core modules (32) arranged in an interval with respect to the path (A), on the outer surface of the magnetic field body (10).

As a result, multiple ultrasonic rotating magnetic fields may be formed in the magnetic field body (10) with gaps between each of fields.

The core modules (32) arranged in multiple stages on the outer surface of the magnetic field body (10) in the above can be arranged according to the user's application and selection, usually between 2 to 6, or preferably in 3.

In another aspect, the present disclosure provides methods to generate hydrogen-reduced water comprising the use of one or more ultrasonic rotating magnetic fields.

In an embodiment, the method comprises passing water through one or more ultrasonic rotating magnetic fields.

In an embodiment, the method comprises the use of a hydrogen-reduced water generation and supply systems disclosed herein. In another aspect, the present disclosure provides methods to increasing plant growth by growing the plant in hydrogen-reduced water obtained by a system or method described herein to a plant. Increasing plant growth can include increasing size, height or mass of a plant, increasing plant yield, increasing root growth, increasing the number of fine roots, increasing the green color of vegetables, increasing seed weight and/or increasing flowering.

In an embodiment, any of the above listed parameters are increased by at least 2%, 5%, 10%, 25%, 50%, 100%, 200%, 300%, 400% or 500% as compared to a plant to which has been grown in non-hydrogen reduced water or as compared to pre-determined standard.

As used herein, the term “grown in hydrogen-reduced water” is used to refer to the use of hydrogen reduced water as the primary water source for the plant. For example, a plant may be watered with hydrogen-reduced water or growth in soil to which hydrogen-reduced water is supplied.

In one embodiment, the plant is a crop plant. In another embodiment, the plant is a Cannabis plant.

Examples of the beneficial effects of the hydrogen-reduced water generated by the methods and/or systems disclosed herein on plants are now described.

### EXAMPLES

### Example 1

### Onion Test

In this test, onion bulbs were kept on treated (“hydrogen-reduced water”) distilled water, untreated distilled water, or tap water. Two onion bulbs were randomly assigned to each of the three groups. Root growth was monitored over a period of 13 days.

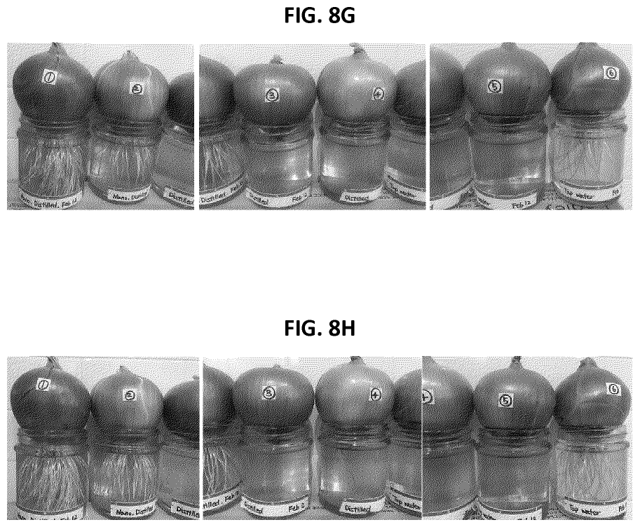

As shown in FIGS. 8A-8H, onions grown with treated (“hydrogen-reduced water”) water showed faster root growth and longer root growth.

### Example 2

### Cannabis Growth Test

In this test, Cannabis clones were grown with hydrogen-reduced water or untreated water and growth was monitored.

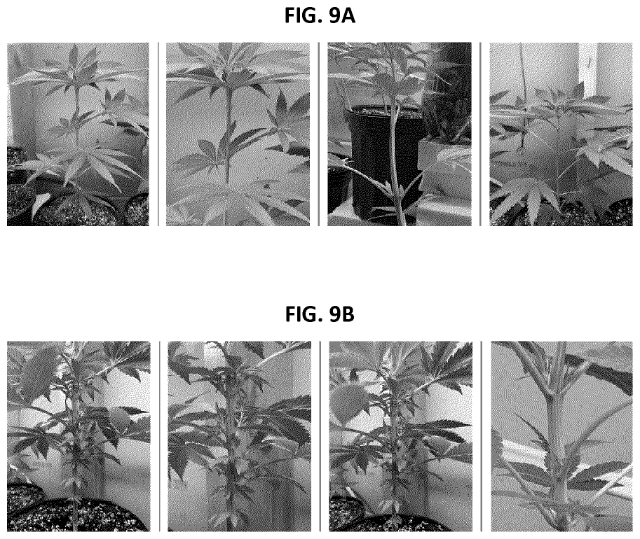

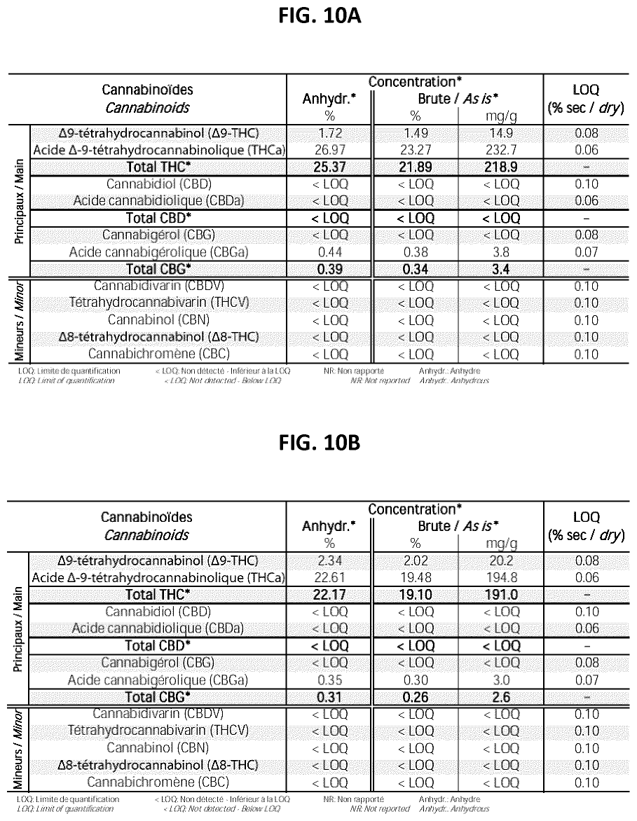

As shown in FIGS. 9A-9B, Cannabis clones grown with treated water shows faster growth (7 days to root when treated water was used; compared with 14 days when untreated water was used), broader leaves, and more branches forming.

Cannabis clones grown with untreated water yielded 2252 g of dry flower. Cannabis clones grown with treated water yielded 2499 g of dry flower, representing 11% increase in yield.

### Example 3

### Cannabis Content Test

Cannabis plants grown with untreated water or treated water were submitted to a third party for analysis of contents of cannabinoids and terpene. The results demonstrated that Cannabis flowers from plants grown with treated water showed equal quality as untreated groups, suggesting the difference in yield was not caused by an increased intake of water.

Cannabis flowers from plants grown with untreated water (control group) yielded 25.37% of total THC, 0.39% of total CBG. Cannabis flowers from plants grown with treated water yielded 22.17% of total THC, 0.31% of total CBG. The difference of THC content was 3.2% and CBG content was 0.08%. The differences are within acceptable range of differences caused by analytical methodologies to consider the two Cannabis samples as having same quality.

Cannabis flowers from plants grown with untreated water (control group) yielded 44.13 mg/g of total terpene contents. Cannabis flowers from plants grown with treated water yielded 42.66 mg/g of total terpene contents. The difference of terpene content was 1.74 mg/g which is within acceptable range of differences caused by analytical methodologies to consider the two Cannabis samples as having same quality.

The embodiment of the present invention described above is merely exemplary, and those of ordinary skill in the art to which the present invention pertains will appreciate that various modifications and equivalent other embodiments are possible. Therefore, it will be well understood that the present invention is not limited to the forms recited in the above detailed description. Also, the true technical protection scope of the present invention should be determined by the technical spirit of the appended claims. It is also to be understood that the present invention includes all modifications, equivalents and substitutions falling within the intension and scope of the invention as defined by the appended claims.

TABLE 1
Terpene content in cannabis grown in untreated water

| Identification | (mg/g) | Class |
|---|---|---|
| Hexanol | 0.02 | Aliphatic alcohol |
| α-Thujene | 0.01 | Monoterpene |
| α-Pinene | 0.37 | Monoterpene |
| Camphene | 0.11 | Monoterpene |
| α-Fenchene | 0.01 | Monoterpene |
| β-Pinene | 0.63 | Monoterpene |
| Sabinene | 0.01 | Monoterpene |
| Myrcene | 2.60 | Monoterpene |
| α-Phellandrene | 0.02 | Monoterpene |
| Δ3-Carene | tr | Monoterpene |
| α-Terpinene | 0.01 | Monoterpene |
| para-Cymene | 0.01 | Monoterpene |
| Limonene | 3.28 | Monoterpene |
| β-Phellandrene | 0.02 | Monoterpene |
| 1,8-Cineole | 0.01 | Monoterpenic ether |
| (Z)-β-Ocimene | 0.01 | Monoterpene |
| (E)-β-Ocimene | tr | Monoterpene |
| γ-Terpinene | 0.01 | Monoterpene |
| cis-Sabinene hydrate | 0.03 | Monoterpenic alcohol |
| Octanol | tr | Aliphatic alcohol |
| Fenchone | 0.03 | Monoterpenic ketone |
| para-Cymenene | tr | Monoterpene |
| Terpinolene | 0.04 | Monoterpene |
| trans-Sabinene hydrate | 0.01 | Monoterpenic alcohol |
| Linalool | 1.16 | Monoterpenic alcohol |
| endo-Fenchol | 0.64 | Monoterpenic alcohol |
| trans-Pinene hydrate | 0.40 | Monoterpenic alcohol |
| cis-Pinene hydrate | 0.06 | Monoterpenic alcohol |
| Camphene hydrate | 0.03 | Monoterpenic alcohol |
| Ipsdienol | 0.04 | Monoterpenic alcohol |
| Borneol | 0.20 | Monoterpenic alcohol |
| Terpinen-4-ol | 0.02 | Monoterpenic alcohol |
| α-Terpineol | 0.56 | Monoterpenic alcohol |
| Citronellol | 0.01 | Monoterpenic alcohol |
| Geraniol | 0.06 | Monoterpenic alcohol |
| Decanol | tr | Aliphatic alcohol |
| α-Cubebene | 0.02 | Sesquiterpene |
| α-Ylangene | 0.03 | Sesquiterpene |
| Unknown | 0.30 | Sesquiterpene |
| Hexyl hexanoate | 0.12 | Aliphatic ester |
| β-Caryophyllene | 9.06 | Sesquiterpene |
| α-Santalene | 0.03 | Sesquiterpene |
| γ-Elemene | 0.28 | Sesquiterpene |
| α-Guaiene | 0.65 | Sesquiterpene |
| trans-α-Bergamotene | [0.65] | Sesquiterpene |
| α-Humulene | 2.79 | Sesquiterpene |
| allo-Aromadendrene | 0.02 | Sesquiterpene |
| (E)-β-Farnesene | 0.10 | Sesquiterpene |
| Unknown | 0.16 | Sesquiterpene |
| β-Selinene | 0.62 | Sesquiterpene |
| Valencene | 0.04 | Sesquiterpene |
| α-Selinene | 0.81 | Sesquiterpene |
| δ-Guaiene | 1.23 | Sesquiterpene |
| β-Bisabolene | 0.16 | Sesquiterpene |
| (3E,6E)-α-Farnesene | 0.10 | Sesquiterpene |
| Spirovetiva-1(10),7(11)-diene | 0.79 | Sesquiterpene |
| Eremophila-1(10),7(11)-diene | 0.20 | Sesquiterpene |
| Selina-4(15),7(11)-diene | 4.16 | Sesquiterpene |
| Unknown | 1.69 | Sesquiterpene |
| Selina-3,7(11)-diene | 6.11 | Sesquiterpene |
| (E)-α-Bisabolene | 0.61 | Sesquiterpene |
| Germacrene B | 0.79 | Sesquiterpene |
| Eudesma-5,7(11)-diene | 0.14 | Sesquiterpene |
| (E)-Nerolidol | 0.14 | Sesquiterpenic alcohol |
| Caryophyllene oxide | 0.19 | Sesquiterpenic ether |
| Guaiol | 0.02 | Sesquiterpenic alcohol |
| Humulene epoxide II | 0.08 | Sesquiterpenic ether |
| Selin-6-en-4α-ol isomer | 0.04 | Sesquiterpenic alcohol |
| 10-epi-γ-Eudesmol | 0.01 | Sesquiterpenic alcohol |
| γ-Eudesmol | 0.05 | Sesquiterpenic alcohol |
| β-Eudesmol | 0.06 | Sesquiterpenic alcohol |
| α-Eudesmol | 0.07 | Sesquiterpenic alcohol |
| Bulnesol | 0.06 | Sesquiterpenic alcohol |
| (3Z)-Caryophylla-3,8(13)-dien- | 0.05 | Sesquiterpenic alcohol |
| 5β-ol | | |
| α-Bisabolol | 1.23 | Sesquiterpenic alcohol |
| Juniper camphor | 0.33 | Sesquiterpenic alcohol |
| Aromadendrane-4,10-diol | 0.07 | Sesquiterpenic alcohol |
| (2E,6E)-Farnesol | 0.20 | Sesquiterpenic alcohol |
| Cryptomeridiol | 0.01 | Sesquiterpenic alcohol |
| meta-Camphorene | 0.01 | Diterpene |
| Phytol | 0.12 | Diterpenic alcohol |
| Consolidated total | 44.13 mg/g | |

* Individual compounds concentration could not be found due to overlapping coelutions on columns considered
[xx]: Duplicate percentage due to coelutions, not taken into account in the consolidated total
tr: <0.005 mg/g

TABLE 2
Terpene content in cannabis grown in treated water

| Identification | (mg/g) | Class |
|---|---|---|
| Hexanol | 0.02 | Aliphatic alcohol |
| α-Thujene | 0.01 | Monoterpene |
| α-Pinene | 0.35 | Monoterpene |
| α-Fenchene | 0.01 | Monoterpene |
| Camphene | 0.11 | Monoterpene |
| β-Pinene | 0.59 | Monoterpene |
| Sabinene | 0.01 | Monoterpene |
| Myrcene | 1.93 | Monoterpene |
| α-Phellandrene | tr | Monoterpene |
| Δ3-Carene | tr | Monoterpene |
| α-Terpinene | 0.01 | Monoterpene |
| para-Cymene | tr | Monoterpene |
| 1,8-Cineole | 0.01 | Monoterpenic ether |
| β-Phellandrene | 0.01 | Monoterpene |
| Limonene | 3.02 | Monoterpene |
| (Z)-β-Ocimene | 0.01 | Monoterpene |
| (E)-β-Ocimene | tr | Monoterpene |
| γ-Terpinene | 0.01 | Monoterpene |
| cis-Sabinene hydrate | 0.04 | Monoterpenic alcohol |
| para-Cymenene | 0.01 | Monoterpene |
| Fenchone | 0.03 | Monoterpenic ketone |
| Terpinolene | 0.04 | Monoterpene |
| trans-Sabinene hydrate | 0.01 | Monoterpenic alcohol |
| Linalool | 1.01 | Monoterpenic alcohol |
| endo-Fenchol | 0.64 | Monoterpenic alcohol |
| trans-Pinene hydrate | 0.42 | Monoterpenic alcohol |
| cis-Pinene hydrate | 0.07 | Monoterpenic alcohol |
| Camphene hydrate | 0.03 | Monoterpenic alcohol |
| Ipsdienol | 0.03 | Monoterpenic alcohol |
| Borneol | 0.18 | Monoterpenic alcohol |
| Terpinen-4-ol | 0.02 | Monoterpenic alcohol |
| α-Terpineol | 0.55 | Monoterpenic alcohol |
| Hexyl butyrate | 0.01 | Aliphatic ester |
| Citronellol | 0.02 | Monoterpenic alcohol |
| Geraniol | 0.08 | Monoterpenic alcohol |
| Decanol | tr | Aliphatic alcohol |
| α-Cubebene | 0.03 | Sesquiterpene |
| α-Ylangene | 0.03 | Sesquiterpene |
| Unknown | 0.31 | Sesquiterpene |
| Hexyl hexanoate | 0.10 | Aliphatic ester |
| β-Caryophyllene | 8.72 | Sesquiterpene |
| α-Santalene | 0.04 | Sesquiterpene |
| γ-Elemene | 0.32 | Sesquiterpene |
| α-Guaiene | 0.58 | Sesquiterpene |
| trans-α-Bergamotene | [0.58] | Sesquiterpene |
| α-Humulene | 2.68 | Sesquiterpene |
| allo-Aromadendrene | 0.02 | Sesquiterpene |
| (E)-β-Farnesene | 0.09 | Sesquiterpene |
| Unknown | 0.15 | Sesquiterpene |
| β-Selinene | 0.61 | Sesquiterpene |
| Valencene | 0.03 | Sesquiterpene |
| α-Selinene | 0.78 | Sesquiterpene |
| δ-Guaiene | 1.09 | Sesquiterpene |
| β-Bisabolene | 0.14 | Sesquiterpene |
| (3E,6E)-α-Farnesene | 0.11 | Sesquiterpene |
| Spirovetiva-1(10),7(11)-diene | 0.72 | Sesquiterpene |
| Eremophila-1(10),7(11)-diene | 0.24 | Sesquiterpene |
| Selina-4(15),7(11)-diene | 4.22 | Sesquiterpene |
| Unknown | 1.11 | Sesquiterpene |
| Selina-3,7(11)-diene | 6.60 | Sesquiterpene |
| (E)-α-Bisabolene | 0.60 | Sesquiterpene |
| Germacrene B | 0.93 | Sesquiterpene |
| Eudesma-5,7(11)-diene | 0.14 | Sesquiterpene |
| (E)-Nerolidol | 0.19 | Sesquiterpenic alcohol |
| Caryophyllene oxide | 0.16 | Sesquiterpenic ether |
| Guaiol | 0.02 | Sesquiterpenic alcohol |
| Humulene epoxide II | 0.06 | Sesquiterpenic ether |
| Selin-6-en-4α-ol isomer | 0.04 | Sesquiterpenic alcohol |
| 10-epi-γ-Eudesmol | 0.01 | Sesquiterpenic alcohol |
| Selin-6-en-4α-ol | 0.01 | Sesquiterpenic alcohol |
| γ-Eudesmol | 0.04 | Sesquiterpenic alcohol |
| β-Eudesmol | 0.06 | Sesquiterpenic alcohol |
| α-Eudesmol | 0.08 | Sesquiterpenic alcohol |
| Bulnesol | 0.05 | Sesquiterpenic alcohol |
| (3Z)-Caryophylla-3,8(13)-dien- | 0.05 | Sesquiterpenic alcohol |
| 5β-ol | | |
| α-Bisabolol | 1.30 | Sesquiterpenic alcohol |
| Juniper camphor | 0.32 | Sesquiterpenic alcohol |
| Aromadendrane-4,10-diol | 0.07 | Sesquiterpenic alcohol |
| (2E,6E)-Farnesol | 0.39 | Sesquiterpenic alcohol |
| Cryptomeridiol | 0.01 | Sesquiterpenic alcohol |
| meta-Camphorene | 0.01 | Diterpene |
| Phytol | 0.09 | Diterpenic alcohol |
| Consolidated total | 42.66 mg/g | |

* Individual compounds concentration could not be found due to overlapping coelutions on columns considered
[xx]: Duplicate percentage due to coelutions, not taken into account in the consolidated total
tr: <0.005 mg/g

While the present application has been described with reference to what are presently considered to be the preferred examples, it is to be understood that the application is not limited to the disclosed examples. To the contrary, the application is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

The scope of the claims should not be limited by the preferred embodiments and examples, but should be given the broadest interpretation consistent with the description as a whole.

1. A system for generating hydrogen-reduced water comprising:
a water movement path;
a magnetic field generating unit to generate one or more ultrasonic rotating magnetic fields along the water movement path;
a high voltage generating unit; and
a control unit configured to supply and manage power to the magnetic field generating unit and to the high voltage generating unit;
wherein the high voltage generating unit is connected to the magnetic field generating unit to boost voltage in the magnetic field generating unit; and
wherein the magnetic field generating unit is radially positioned with respect to the ultrasonic rotating magnetic field.

2. The system of claim 1,
wherein the magnetic field generating unit comprises one or more core modules along the water movement path;
wherein each of the one or more core modules comprises one or more cores; and
wherein the one or more cores is configured to receive power from the control unit.

3. The system of claim 2,
wherein the one or more core modules is at least two core modules; and
wherein the at least two core modules are arranged along the water movement path in series.

4. The system of claim 3, wherein the at least two core modules is between 2 and 8 modules.

5. The system of claim 3, wherein the at least two core modules is 6 modules.

6. The system of claim 1, further comprising:
a storage tank connected to the water movement path by a circulation pipe, the storage tank for receiving and storing at least one of hydrogen-reduced and untreated water; and
a supply pump connected to the circulation pipe to provide kinetic energy to the water.

7. The system of claim 6, further comprising a supply pipe connected to the supply pump to supply water from a source external to the system.

8. The system of claim 1, wherein water is applied to the water movement path and hydrogen-reduced water is obtained by passing the water through the one or more ultrasonic rotating magnetic fields along the path.

9. A method to generate hydrogen-reduced water, the method comprising passing water through one or more ultrasonic rotating magnetic fields to obtain hydrogenreduced water.

10. The method of claim 9, wherein the pH of the hydrogen-reduced water is 7.5 to 8.

11. A method for increasing plant growth by growing the plant in the presence of hydrogen-reduced water obtained by the system of claim 1.

12. The method of claim 11, wherein the plant is a Cannabis plant.

13. The system of claim 4, wherein the at least two core modules is 6 modules.

14. A method to generate hydrogen-reduced water, the method comprising passing water through one or more ultrasonic rotating magnetic fields from a system of claim 1, to obtain hydrogen reduced water.

15. The method of claim 14, wherein the pH of the hydrogen-reduced water is 7.5 to 8.
